(19) United States
(12) Patent Application Publication
(10) Pub. No.: US 2013/0160613 A1
(43) Pub. Date: Jun. 27, 2013

(54) DRIVING TOOL

(71) Applicant: Michael Brailey, Koln (DE)

(72) Inventor: Michael Brailey, Koln (DE)

(73) Assignee: SMC CORPORATION LIMITED, NOTTINGHAMSHIRE (GB)

(21) Appl. No.: 13/698,831

(22) PCT Filed: May 3, 2011
(86) PCT No.: PCT/GB11/50860

§ 371 Date: Mar. 13, 2013

(30) Foreign Application Priority Data
May 19, 2010 (GB) 1008312.9

(51) Int. Cl. B25B 13/32

(52) U.S. Cl. CPC B25B 13/32
USPC 81/111

(57) ABSTRACT

A driving tool (102) comprises a socket (108) mounted at an end of a shaft (103). Shaft (103) has a deformable shaft portion. The socket (108) comprises a plurality of resilient jaws (110) which are adapted to be compressed together to grip a head of a fastener. A sleeve (105) comprises a deformable portion (106). The sleeve (105) is slidably mounted on shaft (103). A collar (118) is mounted to the end of sleeve (105) and is slidable along deformable shaft portion (104) and over jaws (110). Length adjustment means is provided to enable adjustment of the length of the deformable shaft or the deformable sleeve. The length adjustment means comprises a first sleeve member (130) having a first threaded portion threaded onto a second threaded portion of a second sleeve member (136).

The present invention relates to a driving tool, and relates particularly, but not exclusively, to a driving tool having a deformable shaft portion and a socket for gripping a fastener such as a nut, bolt or screw.

Driving tools for tightening and loosening fasteners may have a socket comprising a plurality of resilient jaws that can be compressed to grip the head of a fastener such as a nut, screw or bolt. This enables the driving tool to be used with fasteners having heads of different diameter.

One such driving tool is described in WO 2008/033425. The driving tool described comprises an inner shaft to which a socket having three compressible jaws is mounted. An outer sleeve having a collar is mounted on the shaft and can be slidably moved along the shaft by an actuation lever. When the lever is depressed, a cam surface pushes the sleeve along the shaft and causes the collar to engage the jaws of the socket and compress the jaws to grip a fastener head. The driving tool can be rotated to tighten or loosen the fastener.

The driving tool of WO 2008/033425 suffers from the drawback that because the shaft is rigid, only fasteners that are easily accessible, i.e. fasteners having an axis of rotation in line with the axis of rotation of the shaft can be accessed. If a fastener is located in an inaccessible location such as in a recess in an internal combustion engine, the driving tool of WO2008/033425 cannot be used.

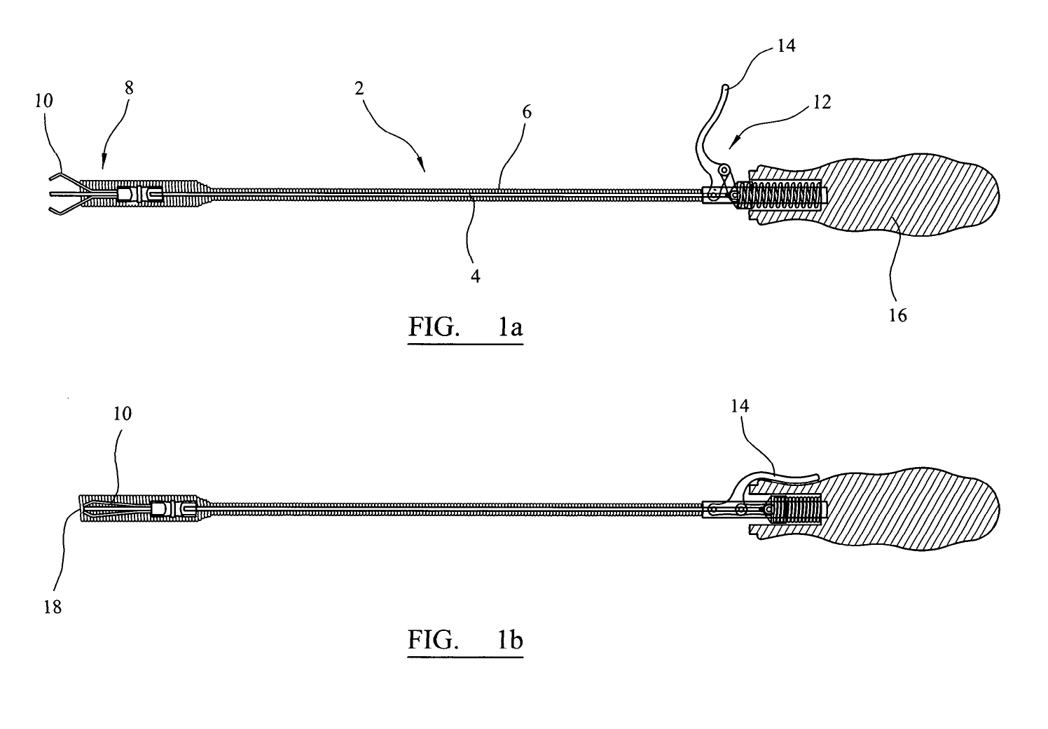

FIGS. 1a and 1b show a solution to this problem. Driving tool 2 comprises a deformable inner shaft 4 on which a deformable outer shaft 6 is slidably mounted. A socket 8 is mounted on the end of shaft 4 and comprises a plurality of resilient jaws 10. Actuation means 12 comprises a lever 14 which when depressed moves the inner shaft into the handle 16 and advances the sleeve 6 along the shaft 4 such that a collar 18 formed on the end of sleeve 6 causes the jaws 10 to be compressed (FIG. 1b).

Consequently, jaws 10 can be compressed to grip a fastener (not shown) to enable tightening or loosening of the fastener. As a result of the fact that the shaft 4 and sleeve 6 are deformable, the shaft and sleeve can be bent around a corner to enable the socket 8 to be used to grip a fastener that is located in an awkward and inaccessible location.

The driving tool 2 of FIGS. 1a and 1b suffers from the drawback that when the shaft and sleeve are bent, the inside edge on the bend is shorter than the outside edge. This can cause the sleeve 6 to compress and shorten. If the sleeve 6 shortens or becomes permanently deformed, the deformation might be such that it is not sufficiently long enough to cause the jaws 10 to compress fully when the lever 14 is depressed.

One solution to this problem is to move the actuation means to the socket end of the tool, i.e. dispense with an outer sleeve altogether. In this type of tool, a collar provided at the socket end of the tool and is threaded onto a thread formed at the end of the shaft. When the collar is rotated, it advances along the shaft to compress the jaws. However, because the collar is located at the socket end of the driving tool, a user must be able to access the collar to tighten the jaws which means that if a fastener is to be accessed that is positioned in an awkward location, the user might not be able to get his or her fingers into the awkward location to tighten the collar. Consequently, this defeats the purpose of having a deformable shaft and sleeve.

Preferred embodiments of the present invention seek to overcome the above disadvantages of the prior art.

According to an aspect of the present invention, there is provided a driving tool comprising:

a shaft comprising a deformable shaft portion;

a socket mounted to the end of the shaft, the socket comprising a plurality of resilient jaws for gripping the head of a fastener;

a sleeve slidably disposed around the shaft, the sleeve comprising a deformable sleeve portion and a collar moveable over said plurality of resilient jaws to compress the plurality of resilient jaws;

actuation means adapted to slide the sleeve relative to the shaft; and

length adjustment means adapted to enable adjustment of the length of the shaft or the sleeve.

By providing length adjustment means adapted to enable adjustment of the length of the shaft or sleeve, this provides the advantage that any permanent compression of the sleeve can be accounted for. Compression of the sleeve results in lost tension when the actuation means is operated, and the length adjustment means therefore provides a means of increasing tension to ensure correct operation of the resilient jaws during gripping of a fastener.

Furthermore, in particularly awkward fastener locations, when the sleeve is bent to a great extent a reduction in tension of the sleeve can result and the length adjustment means therefore enables provision of further tension in such a situation.

In a preferred embodiment, said length adjustment means comprises a first sleeve member disposed around the shaft, the first sleeve member comprising a first threaded portion; and

a second sleeve member disposed around the shaft, the second sleeve member comprising a second threaded portion threaded onto the first threaded portion, wherein length of the sleeve can be adjusted by threading the first sleeve member relative to the second sleeve member.

This provides the advantage of a relatively straightforward and reliable mechanism for enabling length adjustment. The length adjustment means can be adjusted both in the condition where the actuation means is actuated to compress the resilient jaws, and when the actuation means is disengaged and the jaws are open. This therefore provides the advantage of a highly adaptable and adjustable mechanism. The driving tool may further comprise a threaded washer disposed on said first or second threaded portion, the threaded washer arranged to abut the first or second sleeve member to prevent threading of the first or second sleeve member relative to the other of the second or first sleeve member.

This provides the advantage of means for locking the length adjustment means at a predetermined length to prevent inadvertent adjustment of the length of the sleeve.

The driving tool may further comprise a handle member mounted to the shaft.

In a preferred embodiment, the actuation means comprises a lever pivotally mounted to the shaft, the lever comprising a cam portion arranged to slide the sleeve along the shaft to move the collar over and compress the plurality of resilient jaws when the lever is pivoted in a first direction.

In a preferred embodiment, the driving tool further comprises biasing means adapted to bias the sleeve along the shaft to enable the plurality of resilient jaws to open when the lever is pivoted in a second direction, opposite to the first direction.

This provides the advantage of ensuring that the resilient jaws of the socket open when the actuation means is disengaged.

Preferred embodiments of the present invention will now be described, by way of example only and not in any limitative sense, with reference to the accompanying drawings, in which:

FIG. 1a is a cross sectional view of a prior art driving tool with the socket in the open condition;

FIG. 1b is a view corresponding to FIG. 1a with the socket in the closed condition;

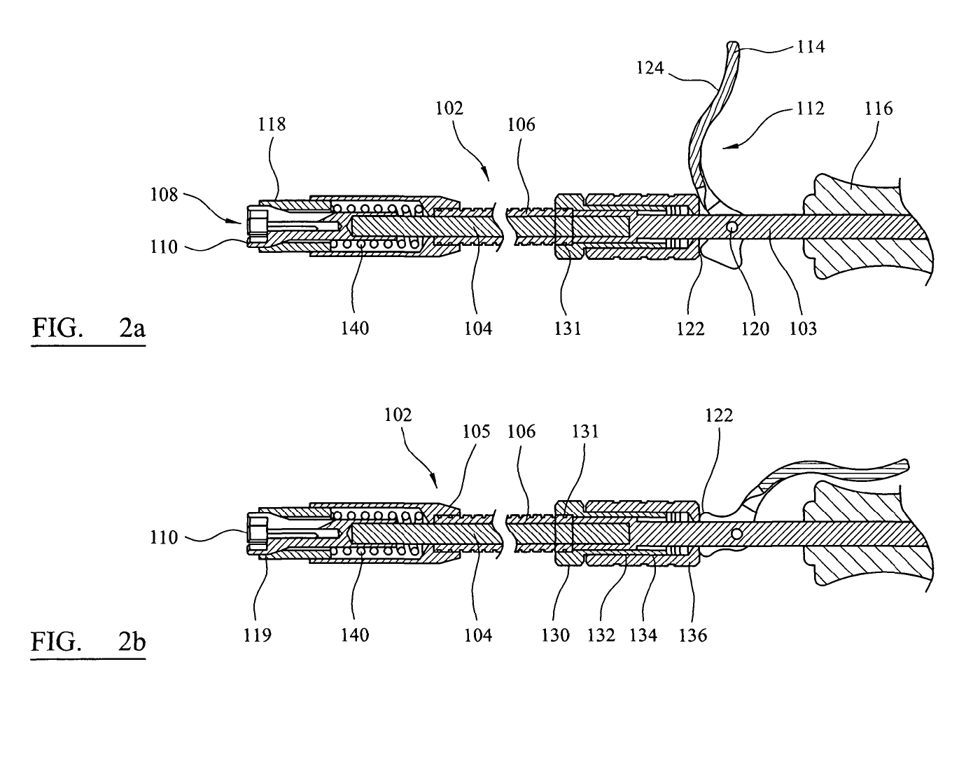

FIG. 2a is a cross sectional view of a driving tool in accordance with a first embodiment of the present invention, the driving tool shown with the socket jaws in the open condition;

FIG. 2b is a view corresponding to FIG. 2a in which the actuation means is activated to compress the socket jaws;

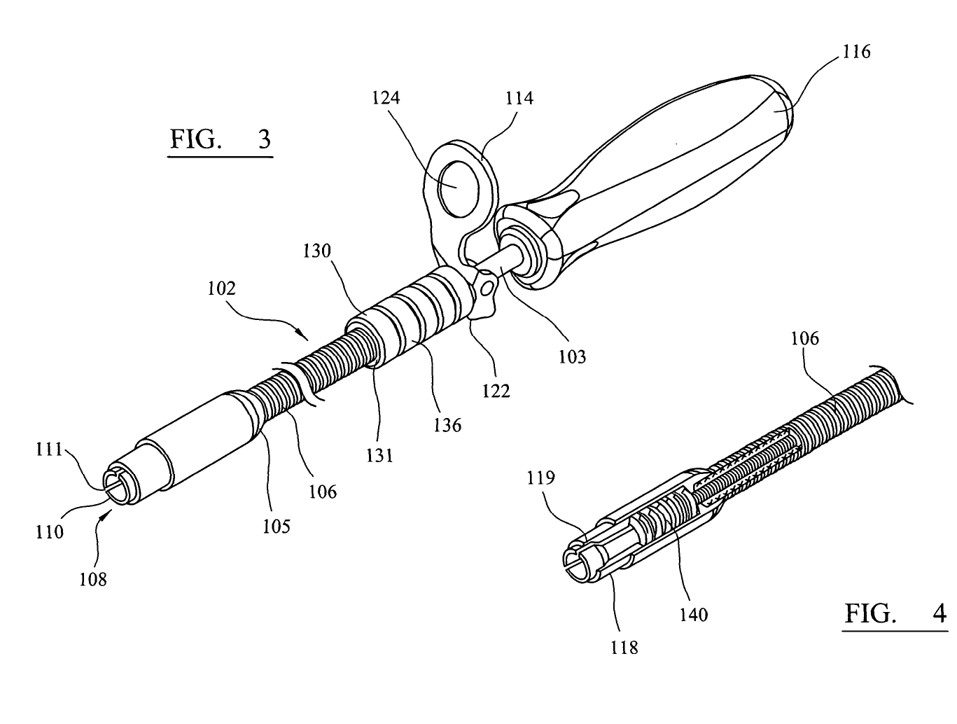

FIG. 3 is a perspective view of the driving tool of FIGS. 2a and 2b;

FIG. 4 is a partially cut-away perspective view of the socket, sleeve and shaft assembly of the driving tool of FIGS. 2 and 3;

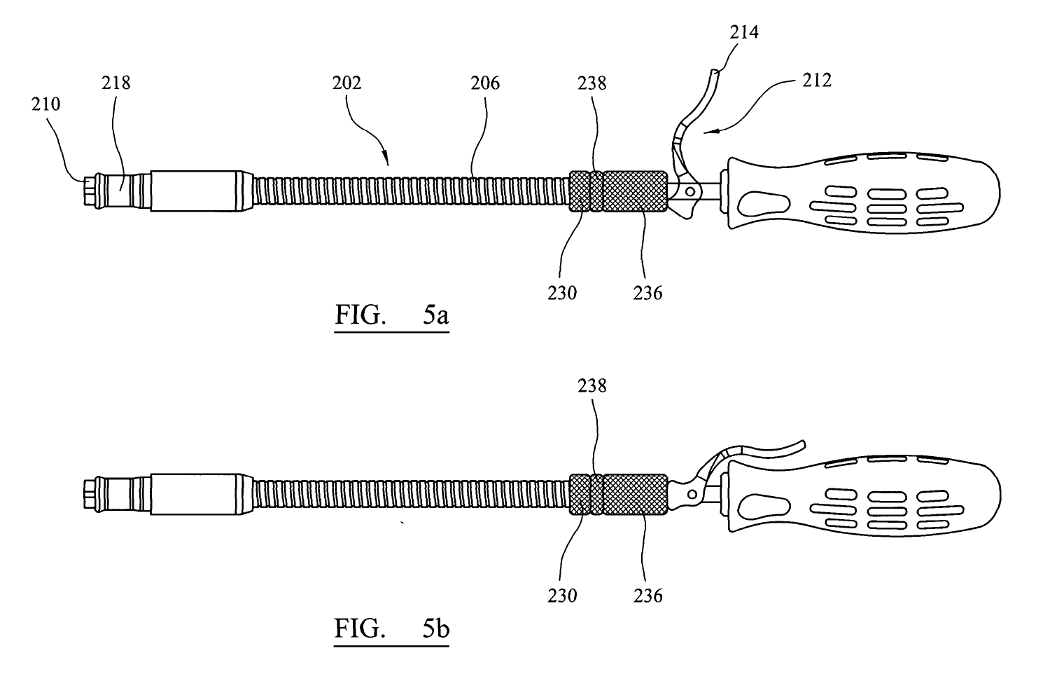

FIG. 5a is a side view of a driving tool of a second embodiment of the present invention, the driving tool shown with the socket jaws in the open condition; and

FIG. 5b is a view corresponding to FIG. 5a in which the socket jaws of the driving tool have been compressed by the actuation means.

Referring the FIGS. 2 to 4, a driving tool 102 comprises a socket 108 mounted at an end of a shaft 103. Shaft 103 has a deformable shaft portion 104. A handle 116 is provided for a user to grip. The socket 108 comprises a plurality of resilient jaws 110 which are adapted to be compressed together to grip a head of a fastener. As shown in FIGS. 3 and 4, the jaws define a substantially hex-shaped internal profile to grip a hexagonal fastener head, although other profiles can be used. The resilience of the jaws enables them to be repeatedly compressed and expanded in use. In the embodiment shown, three jaws 110 are provided and are separated by three corresponding gaps 111.

A sleeve 105 comprises a deformable portion 106. The sleeve 105 is slidably mounted on shaft 103. The deformable portions 106, 104 of the sleeve and shaft are formed from tightly coiled springs and are deformable to the extent that when they are bent, they hold the shape of the bend once a user has released their grip. Consequently, when bent, the sleeve and shaft do not resume the straight shape shown in the drawings until they are moved to that configuration by a user. The sleeve and shaft can therefore be repeatedly deformed to a bent condition (to enable engagement with a fastener around a corner) and then straightened to the configuration shown in the drawings.

A collar 118 is mounted to the end of sleeve 105, although it should be understood that the collar 118 could actually be part of the sleeve 105 rather than a separate component. The collar 118 is slidable along deformable shaft portion 104 and over jaws 110. Internal surface 119 is provided in collar 118 to pinch together and compress the jaws 110 when the collar moves over the jaws.

Actuation means 112 comprises a lever 114 pivotally mounted to shaft 103. A cam surface 122 is provided at an end of the lever 114. A button 124 is also provided on the lever to enable a user to depress the lever 124 with his or her thumb when gripping the handle 116.

Length adjustment means is provided to enable adjustment of the length of the deformable shaft or the deformable sleeve. In the embodiment shown, the length adjustment means comprises a first sleeve member 130 having a first threaded portion 132. The first threaded portion 132 is threaded onto a second threaded portion 134 of a second sleeve member 136. When the first 130 and second 136 sleeve members are threaded relative to one another such that the first sleeve member 130 moves out of the second sleeve member 136, the deformable sleeve portion 106 is advanced along shaft 103 because the deformable sleeve portion is mounted to the first sleeve member 130 at connecting portion 131. This effectively increases the length of the sleeve 105.

Biasing means such as a compression spring 140 is provided to bias the sleeve 105 in a return direction along the shaft 103 when the actuation means 112 is disengaged. This configuration is shown in FIGS. 2A and 3.

Operation of the driving tool of FIGS. 2 to 4 will now be described. In order to compress jaws 110 around a fastener head, the resilient jaws 110 are placed around the head of a fastener (not shown). This may involve bending the shaft 103 and sleeve 105 around a corner to access a fastener that is positioned in an awkward location.

A user then depresses button 124 which pivots lever 114 about pin 120. This causes cam surface 122 to push the sleeve 105 along the shaft 103 to cause collar 118 to advance over resilient jaws 110. As this happens, internal surface 119 of collar 118 compresses jaws 110 to grip a fastener head (not shown) over which the resilient jaws 110 are located.

If repeated use has been made of the driving tool, the deformable portion 106 of sleeve 105 may have become permanently compressed. This can result from the inside edge of a bend being shorter than an outside edge of the bend. In this case, the first sleeve member 130 can be rotated relative to second sleeve member 136 to lengthen shaft 105. This takes up the slack caused by the compression of the deformable sleeve portion 106 and therefore enables tension at the collar 118 to be increased. Furthermore, since the length adjustment means can be located at the handle of the driving tool, a user does not have to place his or her fingers in a location at the collar end of the tool to increase tension.

When the lever 114 is opened, i.e. in moving from the configuration of FIG. 2b to FIG. 2a, spring 140 pushes the sleeve 105 back along the shaft 104 in the return direction to ensure that jaws 110 open to release the fastener head.

Referring to FIGS. 5a and 5b, a driving tool of a second embodiment of the invention is shown with parts common to the embodiments of FIG. 2 to 4 shown with like reference numerals, but increased by 100.

Driving tool 202 comprises a sleeve having a deformable sleeve portion 206 disposed around a shaft (not shown). Actuation means 212 comprises a lever 214 used to advance deformable sleeve 206 in order to cause a collar 218 to close resilient jaws 210. Length adjustment means comprises a first sleeve member 230 and a second sleeve member 236 which are threadably interconnected. In particular, an outer thread (not shown) formed on first sleeve member 230 is threaded into a threaded recess (not shown) formed in the second sleeve member 236. A threaded washer 238 is threaded onto the thread of first sleeve member 230. The threaded washer 238 provides a stop to prevent rotation of the second sleeve member 236 past the point on the thread of the first sleeve member 230 at which the threaded washer 238 is located. This provides a locking mechanism for the length adjustment means.

It will be appreciated by persons skilled in the art that the above embodiments have been described by way of example only and not in any limitative sense, and that various alterations and modifications are possible without departure from the scope of the invention as defined by appended claims. For example, a length adjustment means comprising interconnected threaded parts may be provided on the shaft instead of the sleeve.

1. A driving tool comprising:
a shaft comprising a deformable shaft portion;
a socket mounted to the end of the shaft, the socket comprising a plurality of resilient jaws for gripping the head of a fastener;
a sleeve slidably disposed around the shaft, the sleeve comprising a deformable sleeve portion and a collar moveable over said plurality of resilient jaws to compress the plurality of resilient jaws;
an actuation device adapted to slide the sleeve relative to the shaft; and
a length adjustment device adapted to enable adjustment of the length of the shaft or the sleeve.

2. A driving tool according to claim 1, wherein said length adjustment device comprises a first sleeve member disposed around the shaft, the first sleeve member comprising a first threaded portion; and
a second sleeve member disposed around the shaft, the second sleeve member comprising a second threaded portion threaded onto the first threaded portion, wherein length of the sleeve can be adjusted by threading the first sleeve member relative to the second sleeve member.

3. A driving tool according to claim 3, further comprising a threaded washer disposed on said first or second threaded portion, the threaded washer arranged to abut the first or second sleeve member to prevent threading of the first or second sleeve member relative to the other of the second or first sleeve member.

4. A driving tool according to claim 1, further comprising a handle member mounted to the shaft.

5. A driving tool according to claim 1, wherein the actuation means comprises a lever pivotally mounted to the shaft, the lever comprising a cam portion arranged to slide the sleeve along the shaft to move the collar over and compress the plurality of resilient jaws when the lever is pivoted in a first direction.

6. A driving tool according to claim 5, further comprising a biasing device adapted to bias the sleeve along the shaft to enable the plurality of resilient jaws to open when the lever is pivoted in a second direction, opposite to the first direction.

7. (canceled)
